(19) United States
(12) Patent Application Publication
(10) Pub. No.: US 2008/0202017 A1
(43) Pub. Date: Aug. 28, 2008

(54) WEIGHTED FISHING LURES

(76) Inventor: Timothy M. Gregory, Alpharetta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/035,679

(22) Filed: Feb. 22, 2008

Related U.S. Application Data
(60) Provisional application No. 60/891,269, filed on Feb. 23, 2007.

(51) Int. Cl. A01K 85/00

(52) U.S. Cl. 43/42.39; 43/42.24

(57) ABSTRACT

A fishing lure that includes a weighting system within the body of the fishing lure. The lure may be a plastisol material with a displacement material embedded within the plastisol. The displacement material may have a density greater than the plastic material, less than the plastic material, or it may be a combination of both. By strategically embedding the material, buoyancy, sinking action and moving action can be controlled or affected. The displacement material can include metallic powder, shaving, pellets or the like, as well as air, STYROFOAM, or other materials.

### CROSS-REFERENCE TO RELATED APPLICATIONS

This application is a non-provisional application being filed under 37 CFR 1.53(b) and claiming priority to United States Provisional Application for Patent filed on Feb. 23, 2007 and assigned Ser. No. 60/891,269, which application is hereby incorporated by reference.

### BACKGROUND OF THE INVENTION

The present invention relates generally to artificial fishing lures, and more particularly to soft artificial fishing lures.

The plethora of fishing tackle items available to the modern-day angler is quite daunting. But the bottom-line goal remains the same across the board—the typical angler is looking for action, bites and hauling in that “big-one”. And although some may believe, some may opine and some may even argue as to what ingredients go into the makeup of a successful angler (i.e., luck, timing, equipment, fortitude, competitiveness, instinct, etc.), few can argue that the smile on the face of a man or woman that has just reeled in Mr. Bass is certainly more satisfying than the smile on the face of those standing by as spectators.

In search of being that company, that designer or that inventor that has contributed to catching that fish and creating that smile, numerous variations, styles and types of lures and fishing equipment have been created, marketed and eventually lost in the back of a tackle box. Anglers and fisherman are always looking for better ways to catch fish—anything that will give man an edge over “the one that got away” is coveted. Over the years, many items have been developed to help improve the sport in many ways. Examples of some devices that have been developed to improve the fishing experience include: a spinner bait that incorporates an articulating connector as described in U.S. Pat. No. 6,082,039 to McGuinness; a lighted fishing lure as described in U.S. Patent Application no. 2006/0096152 to Pelegrin; and a weighted shank fish hook described in U.S. Patent Application no. 2006/0191187 to Falcon.

A wide variety of artificial fishing lures are currently available to fishermen and anglers. These artificial fishing lures can be classified as one of two types: hard fishing lures or soft fishing lures. Hard fishing lures are those artificial lures that are constructed of wood, metal, hard plastic materials or a combination of two or more those materials. In contrast, soft lures are constructed of one or more plastisol or soft plastic materials through which one or more hooks can be inserted. One of the advantages of plastisol lures is that a variety of hooks can be used with them in a variety of presentations. Soft artificial lures may also provide a more natural appearance and feel. Soft artificial lures are well known and are generally molded, formed or otherwise made from a plastisol material such as a synthetic polymer or resin or rubber. Soft artificial lures are available in a variety of shapes and configurations including, but not limited to: worms with and without tails, lizards, grubs, jerkbait shaped soft lures such as a SENKO soft jerk baits, minnows and other baitfish such as flukes, crawfish, tubes, frogs, eels, shrimp, squid and other fish, amphibian, insect and animal mimics. A few of these shapes are illustrated in the accompanying drawings. Generally, soft artificial lures are fished in combination with a separate weight, for example a lead sinker or jig head, so that the artificial lure can be cast to a desired location, fished below the surface, either on the bottom or at a particular depth.

However, the use of a separate weight, jig head and/or sinker can adversely affect the performance of a lure. A few of these adverse affects include (a) an increased likely to snag the lure or line in wood, grass, and rocks; (b) the heavy weight outside of the worm or lure negatively affects the life-like appearance of the bait (i.e., the bait tends to spiral and plunge with an exterior weight, rather than mimic a living creature); (c) sinkers can get in the way of the hookset, essentially deflecting the creature's flesh as the lure passes out of its mouth allowing the hook to easily slide by without catching when it has a weight “blocking” for it; (d) skipping under overhangs and docks can be done better with no exterior weight; (e) an exterior weight can add an unnatural glare or shine which can spook a fish; and (f) there is a greater risk of line breakage while fighting a fish when you have a weight on the line (the weight is basically just more hard surface and edge with which to fray the line under such circumstances). Thus, there is a need in the art to eliminate the use of exterior weights in typical fishing rigs or line set ups.

One of the needs for artificial lures is that their action in the water needs to resemble that of live bait. Such needs have been the basis for the development of spinner bait and other lures that cause “life-like” movement as they are pulled through the water. As such, there remains a need in the art for lures that operate in such a manner.

Thus, there is a need in the art for lure that can provide weighting and can be weighted in such a manner that provides “life-like” movement of the lure as it passes through the water.

### BRIEF SUMMARY OF THE INVENTION

The present invention is directed towards a lure that is impregnated, injected, molded or otherwise constructed in a manner that material of various densities can be included in the body of the lure to create desired effects. For instance, in one embodiment of the invention a plastisol lure includes a substantially uniformly distributed material, such as metal powder, shavings, pellets, etc. through out the body of the lure. Advantageously, the lure can be infused with enough such material, typically, a material type that has a density that is greater than the pastisol, to totally eliminate the need for additional and/or external (external to the lure) weighting on the rig. In another embodiment, the lure can be strategically constructed so that areas of the lure include heavier or denser portions of the material. Advantageously, this aspect of the invention cannot only eliminate the need for extra weights, but can also have an effect on the action (such as simulating real life bait movement) of the lure as it sinks and as it passes through the water.

In other embodiments, air or material with a lower density than the plastisol can be used to create other effects on the lure. Further, embodiments may employ a combination of material that is denser than the plastic and less dense than the plastic.

The lures can be injection molded by using a molten material that is already infused with a material, such as metallic powder or shavings. In other embodiments, the material can be injected into the plastic material as it is jelling or even a fully cured lure.

Thus, one of the objects of the present invention is to provide a soft artificial fishing lure that can be fished successfully without the addition of a separate weight, jig head or sinker. Other objects will occur to those of skill in the art in light of the following description and accompanying drawings.

### BRIEF DESCRIPTION OF THE SEVERAL VIEWS OF THE DRAWING

A full and enabling disclosure of the present invention, including the best mode thereof is set forth in the detailed description which makes reference to the appended figures in which:

FIG. 1A is an exterior side view of an exemplary artificial worm suitable for embodiments of the present invention;

FIG. 1B is a longitudinal cross-sectional view of one embodiment of the artificial worm of FIG. 1;

FIG. 1C is a lateral cross-sectional view of the embodiment of FIG. 1B taken at line A;

FIG. 2A is an exterior side view of an exemplary tube bait suitable for embodiments of the present invention;

FIG. 2B is a lateral cross-sectional of the tube of FIG. 2A taken though line B;

FIG. 3A is a longitudinal cross-sectional view of another embodiment of the invention showing a non-uniform distribution of displacement material;

FIG. 3B is a lateral cross-sectional view of the embodiment of FIG. 3A taken though line C;

FIG. 3C is a lateral cross-sectional view of the embodiment of FIG. 3A taken though line D;

FIG. 4 is an exterior side view of a jerk bait such as a SENKO type jerk bait, suitable for embodiments of the present invention;

FIG. 5 is an longitudinal cross-sectional view of another embodiment of the present invention showing areas with varying densities of the displacement material;

FIG. 6A is an exterior side view of a minnow-shaped bait such as a fluke, suitable for embodiments of the present invention;

FIG. 6B is an longitudinal cross-sectional view of the fluke of FIG. 6A showing an inserted weight; and

FIG. 6C is a lateral cross-sectional view of the fluke of FIG. 6B taken though line E.

### DETAILED DESCRIPTION OF THE INVENTION

The present invention, as well as features and aspects thereof, is directed towards a fishing lure that includes embedded objects that can alter the weighting of the lure to effect the buoyancy and action of the lure as it is moved through a medium.

The drawings and detailed description provide a detailed written description of the various embodiments, features and aspects of the present invention, and of a manner and process of making and using such embodiments. The detailed description uses numerical and letter designations to refer to features in the drawings. Like or similar designations in the drawings and description have been used to refer to like or similar parts of the invention. The examples set forth in the drawings and detailed description are provided by way of explanation of the invention and are not meant as limitations of the invention. The present invention thus includes any modifications and variations of the following examples as come within the scope of the appended claims and their equivalents.

One aspect of the present invention is to provide an artificial lure with increased weight. More desirably, aspects of the present invention may provide artificial lures with increased density. For instance, in an exemplary embodiment of the present invention, artificial lures can be cast without the addition of a separate weight, jig head or sinker. It should be appreciated that throughout this description, the terms weight, jig head and sinker maybe used interchangeably and it one term is used, it generally incorporates the other terms as well. One aspect of the present invention includes artificial lures that sink in fresh water and may have a density greater than 1 gram per cubic centimeter (g/cm3). Another aspect of the present invention includes artificial lures that sink in saltwater and may have a density greater than 1.025 g/cm3. Another aspect of the present invention is that the artificial lures can mimic the sinking rates of natural and/or wounded baits, for example earthworms, crayfish and other creatures that fish feed upon. Another aspect of the present invention is the application of different weightings to the artificial lures to alter the sinking characteristics of the artificial lures. As a non-limiting example, the artificial lures can have:
(a) a density greater than about 1.1 g/cm3 and, thus, sink at an appreciable rate;
(b) a density greater than about 1.2 g/cm3 and sink at a faster rate;
(c) a density greater than about 1.3 g/cm3 and sink at a still faster rate;
(d) a density greater than about 1.4 g/cm3; or
(e) a density greater than about 1.5 g/cm3.

Soft artificial lures of the present invention can be formed by molding a synthetic resin using methods for molding highly plasticized resins. A suggested non-limiting example of a method that can be used to mold or otherwise form an artificial lure of the present invention which is well known is injection molding. A variety of resins can be used in accordance with this invention. Exemplary resins are desirably soft and flexible and more desirably simulate the appearance, movement and/or texture of live bait. Suggested resins for forming soft artificial lures of the present invention are well known and may include, but are not limited to: vinyl resins and vinyl plastisols, for example, low molecular weight polyvinyl chloride, medium molecular weight polyvinyl chloride, blends of low and medium molecular weight polyvinyl chloride, and equivalent vinyl plastisols; highly plasticized polyvinyl chloride (PVC); vinyl chloride copolymers; silicones; polyurethanes and other resilient plastics. Vinyl plastisols are heavily plasticized and may contain from about 30 percent to about 65 percent by weight of one or more plasticizers based on total weight of the resin formulation used to form the artificial lure of the present invention. Examples of suggested plasticizers include, but are not limited to, phthalate and adipate esters of alcohols such as dioctyl phthalate, dicapryl phthalate, dioctyl adipate, dioctyl sebacate, and so forth and include mixtures of two or more plasticizers. Stabilizers, fillers, pigments, gel thixotropic agents, solvents, flow control agents, lubricants, fish attractants, flavor ingredients and other customary additives may also be included in the compositions used to mold or otherwise form the artificial lures of the present invention.

In one embodiment of the present invention, an artificial lure is formed from a mixture that includes metal or some other higher density material mixed or dispersed in the resin that is used to form the artificial lure to increase the density of the artificial lure or portions of the artificial lure. For instance, the higher density material may include metal particles, metal powder, metal dust, etc., formed from tungsten and alloys of tungsten and may include other metals or alloys such as gold, silver, platinum, osmium, lead, brass and so forth. Further, in a particular embodiment, the metal particles may be tungsten particles or particles of an alloy that includes at least 50 percent by weight of tungsten or higher. For instance, an embodiment may include about 90 percent by weight of tungsten or even as high as about 95 percent or more by weight of tungsten. In certain embodiments, the metal particles or powder consist predominantly of particles of tungsten, an alloy of tungsten or a mixture thereof. It will be appreciated that the higher density substance could also be a higher density plastic, silicon or resin based substance. In addition, the higher density substance may include metal shavings, metal wires, metal fibers, metal balls, metal pellets, metal rods, or the like. Likewise, the higher density substance may include substances such as glass particles, sand, rock materials, or the like. Thus, although the use of one or more of the above-described substances provided as non-limiting examples may in and of themselves be considered as novel, the present invention is not necessarily limited to any particular higher density substance.

Similarly, rather than the employment of a higher density substance, the present invention also anticipates using a substance of lesser density than the material used to fabricate the artificial lure. For instance, a portion of the lure may be injected with air to decrease the density of all or a portion of the lure, or other substances that have a lesser density may also be used. Thus, a lure fabricated from one material, such as a plastisol, can have a displacement material injected or dispersed within the plastic material to alter the weighting characteristics of the lure. Further, the displacement material can be of a weight or density that is substantially different from the plastisol material—more or less dense, or a mixture of both. As further described below, for artificial lures that include varying densities, use of a lesser density substance in conjunction with the higher density substance can advantageously create a wide variety of lures with various sinking and movement characteristics. For purposes of simplicity, the embodiments further described herein will reference the use of metal particles to obtain an increased density; however, it will be appreciated that such focus is to help provide clarity to the description rather than to imply any limitations on the various embodiments of the present invention.

In one embodiment, the metal particles are substantially uniformly distributed throughout the resin that is used to form the artificial lure so that the artificial lure has relatively uniform density throughout its length and or width. Tungsten and/or other metal particles can be blended into the resin formulation prior to forming an artificial lure from the metal particle containing composition. In one embodiment, metal particles are blended or otherwise mixed into the resin composition while the composition is melted or in a liquid state. Generally, the resin forms a continuous phase and the particles form a discontinuous or disperse phase. Suggested metal particle sizes include, but are not limited to, particles having an average largest dimension or largest diameter ranging from approximately 3 millimeters (mm) to less than 0.05 mm.

Artificial lures of the present invention may include a sufficient quantity of metal particles or metal powder so that the artificial lure has a particular density and sinks at a particular rate. It is desirable that the artificial lure sinks at a rate that appears natural or desirable to fish without the addition of a separate weight or sinker. As such, the percentage by weight of metal particles or metal powder can be adjusted to obtain desired sinking rates. Thus, it is anticipated that various embodiments of the invention may have differing percentages of metal particles and although the present invention is not limited to any particular percentage, the selection and deployment of particular percentages may in and of themselves be considered novel. For instance, it is anticipated that artificial lures may include approximately 5, 10, 20, 40 and 50 percent by weight or greater of metal particles or metal powder.

In a first illustrated embodiment, the body of the plastisol artificial lure of the present invention is formed from a mixture of plastisol and particles of metal that are substantially uniformly dispersed in the plastisol that is used to form the artificial lure to produce a plastisol artificial lure having substantially uniform but increased density. It should be appreciated that in other embodiments, to obtain differing movement characteristics of the lure as it sinks or as it is pulled through the water, the density of the metal particles may vary within the lure. For instance, as a non-limiting example, the density in the tail and head region of a lure may be greater than that in the middle of the lure to facilitate a swimming characteristic.

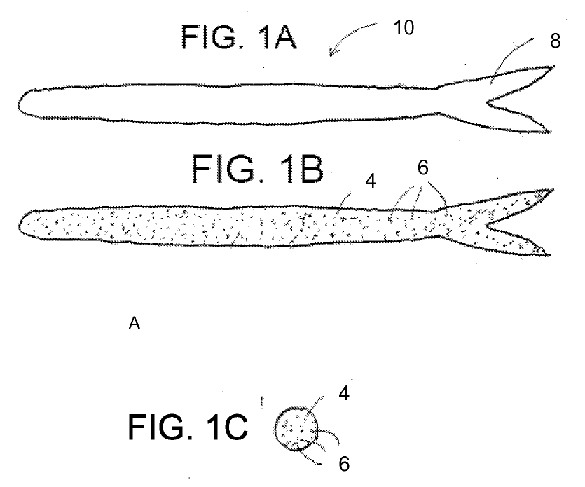

FIGS. 1A, 1B and 1C are examples of a plastisol artificial lure that is fabricated to include a substantially uniform density. More specifically, FIG. 1A is an exterior side view of an exemplary artificial worm suitable for embodiments of the present invention. The illustrated exterior shows an artificial worm 10 that includes a split tail 8. FIG. 1B is a longitudinal cross-sectional view of one embodiment of the artificial worm of FIG. 1. FIG. 1B is shown as including particles of a material, such as a metallic material, that are substantially uniformly dispersed in the plastisol used to form an artificial lure. The illustrated embodiment of the artificial worm 10 includes metal particles 6 that are substantially uniformly distributed through the plastisol 4 that is used to form the worm. Such an artificial worm would have a lateral cross section, such as at line A, as illustrated in FIG. 1C. FIG. 1C illustrates the plastisol resin 4 as a continuous phase and the particles 6 as a discontinuous or disperse phase that is distributed relatively uniformly through the continuous plastisol phase.

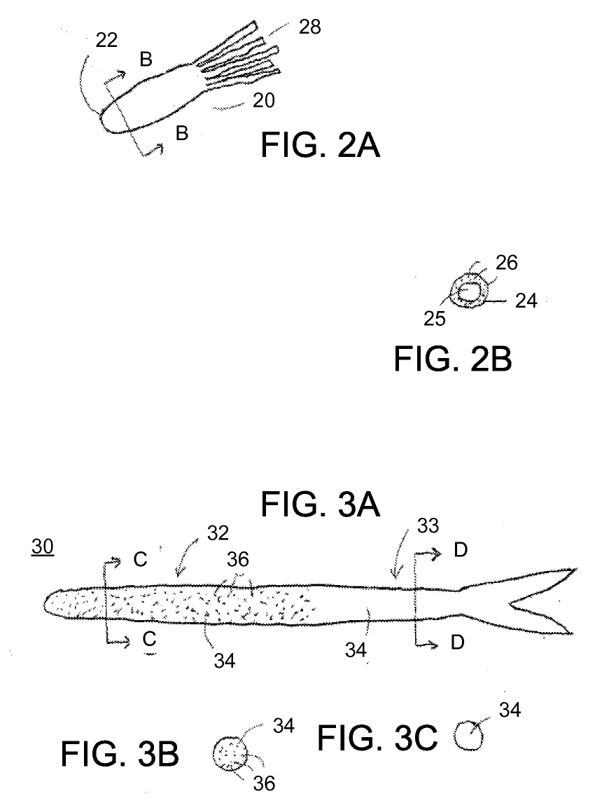

FIG. 2A is an exterior side view of an exemplary tube bait suitable for embodiments of the present invention and FIG. 2B is a lateral cross-sectional of the tube of FIG. 2A taken though line B. FIG. 2A provides a second example of an embodiment of the present invention and illustrates an exterior side view of an exemplary tube bait 20. FIG. 2B illustrates that the tube bait has a hollow body. The tube bate could be formed from a plastisol material 24 that includes metal particles 26 that are substantially uniformly distributed through the plastisol 24 that is used to form the tube bait 20. The tube bait 20 includes a closed head portion 22, a hollow interior portion 25 and an open tail portion 28.

Another aspect of the present invention is that the weighted material may be distributed in a non-uniform manner within the lure to create certain effects, such as sinking characteristics or movement tendencies. For instance, in some embodiments, one end of a plastisol artificial lure, for example the head end or the tail end of the plastisol worm, is formed from a mixture of the plastisol and particles of metal that are substantially uniformly dispersed in the plastisol that is used to form one end or one regions of the plastisol artificial lure so that the artificial worm is weighted toward one end or one regions. The other end of such a plastisol artificial lure can be formed from the same plastisol resin without metal particles or can be formed from a different plastisol resin, for example a differently colored plastisol resin, to from a bicomponent plastisol artificial lure.

FIG. 3A is a longitudinal cross-sectional view an embodiment of the present invention in which the particles of metal are substantially uniformly dispersed in only one end or region of the material used to form an artificial lure. In this illustrated embodiment, metal particles 36 are substantially uniformly distributed through the plastisol 34 that is used to form the head portion 32 of the worm 30. The tail portion 33 of the worm 30 in this illustrated embodiment is made from a plastic resin 34 that contains no metal particles, a negligible amount of metal particles or simply a reduced density of metal particles. Such an artificial worm would have lateral cross sections as illustrated in FIGS. 3B and 3C taken through lines C and D of FIG. 3A respectively. Alternatively, the tail end 33 could contain some metal particles but at a noticeably lesser concentration, for example 10 percent less, metal particles 36 than the concentration of metal particles in the head portion 32 or head end. The plastisol worm described and illustrated in this second embodiment should stand up like a jig under water, specifically in a head down and tail up orientation, thereby obtaining the appearance benefits of a jig without the risk of snags caused by the inclusion of a separate weight with a jig.

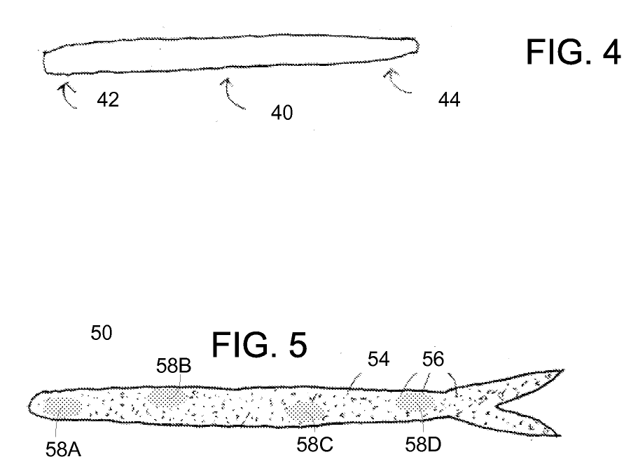

FIG. 4 illustrates the exterior side view of an exemplary jerk bait such as a SENKO type jerk bait. The body of the jerk bait 40 is substantially cylindrical and has narrowed ends 42 and 44. The tail end 44 is typically narrower or more pointed than the head end 43. The jerk bait could be formed from a single metal particle filled plastisol composition to form a soft jerk bait with increased density as described above with respect to FIGS. 1A, 1B and 1C. Alternatively, a jerk bait could be formed from one or more plastisol compositions, at least one of which contains a greater concentration of metal particles to provides a soft jerk bait with increased but not uniform density as described with respect to FIGS. 3A, 3B and 3C. It will be appreciated that the non-uniform distribution of the metal or weighted items can take on a variety for forms. For instance, weighted spots can be placed at strategic locations along a bait to cause certain sinking or movement characteristics.

FIG. 5 illustrates another embodiment of the present invention having multiple pockets or regions with higher density weighted material. In the illustrated embodiment, the worm 50 includes a soft resin material 54 and has weighted particles 56 distributed throughout the entire body of at least a portion of the body. Four distinct regions 58A, 55B, 58C and 58D are shown with a higher density of particles than the rest of the body of the worm 50. Thus, advantageously various actions, movements, sinking patterns, etc. can be achieved by varying the location of the higher density regions of the weighted matter within the body of a lure.

It is desirable that the plastisol artificial lures of the present invention although having increased weight, more specifically increased density, are not visually distinguishable, at least for fish, from similarly shaped, non-weighted plastisol artificial lures. Advantageously, plastisol artificial lures of the present invention can be fished without a sinker which will result in an increase in hook-up ratio. It is also believed that artificial lures of the present invention have improved feel or sensitivity due to the omission of a separate sinker. It has also been suggested that sinkers deflect hook set and increase the probability of snagging on weeds and other obstructions.

Another aspect of the present invention is the provision of various methods of making a plastisol lure. One method includes: suspending metal particles in a liquid plastisol formulation, heating the plastisol formulation that includes metal particles to at least about the plastisol's fusion temperature; shaping the plastisol formulation in a mold to form a plastisol lure body and allowing the plastisol lure body to cool. In another embodiment, the present invention provides a method of making a plastisol lure, the method including: suspending metal particles in a first plastisol formulation, such as by injecting the material into wet plastic, heating the first liquid plastisol formulation that includes metal particles dispersed in the plastisol formulation to at least about the first plastisol's fusion temperature, heating a second liquid plastisol formulation; shaping the first plastisol formulation containing metal particles in a first portion of a mold to form a first portion of plastisol lure body, shaping the second plastisol formulation in a second portion of a mold to form a second portion of plastisol lure body and allowing the plastisol lure body to cool. Advantageously, this embodiment allows for weighted portions of the lure to be created with a high concentration of the weighted material while other portions of the lure do not have any weighted material. In even another embodiment, the weighted material can be injected into the plastisol material. The injection can take place while the plastic material is in a molten state, a wet state, a jelling state or even fully cooled and jelled. Advantageously, such an embodiment, as well as other embodiments, does not have the effect of discoloring or graying the plastic material. In still yet another embodiment, the present invention provides a method of making a plastisol lure where the method includes providing a weighted portion, for example a metal insert or an injected powder, and forming a body of a plastisol artificial lure from a mixture a plastisol around the weighted portion. Desirably, the metal insert is substantially enveloped or substantially contained within the plastisol material that forms the body of the plastisol bait.

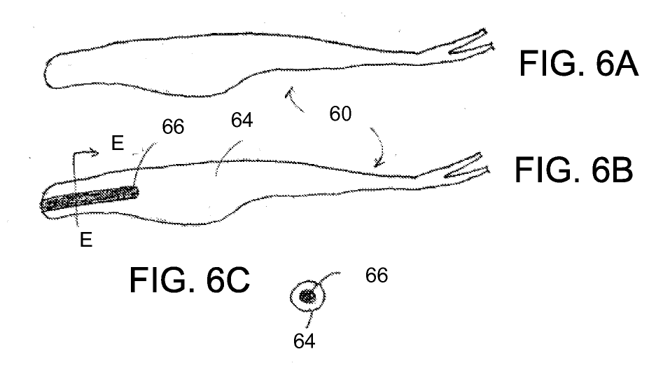

FIGS. 6A, 6B and 6C. FIG. 3 illustrates an exterior side view of an exemplary artificial minnow in the shape of a fluke employing a metal insert embodiment of the present invention. The fluke 60 includes a metal insert 66 that is substantially surrounded by or encapsulated in a plastisol material 64 that forms the body of the soft artificial lure as illustrated in longitudinal cross-section of FIG. 6B and lateral cross-sectional of FIG. 6C taken though line E of FIG. 3A. In an exemplary embodiment, the insert includes or otherwise is made from tungsten or an alloy that can include at least 50 percent by weight of tungsten, or ranging up to 90 percent or even 95 percent by weight of tungsten. This method and the previous method described above can be used to form a soft artificial lure that is weighted toward one end. The weighted end can be the head end, as illustrated, the tail end or even another portion of the artificial lure if desired.

Soft artificial lures of the present invention can be provided in various shapes, sizes, colors, softness and resiliencies. While the present invention has been described in connection with certain illustrated embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

1. A plastisol fishing lure comprising: a plastisol material and a displacement material embedded within at least a portion of the plastisol material, the embedded displacement material having a density that is substantially different from the density of the plastisol material.

2. The plastisol fishing lure of claim 1, wherein the displacement material has a higher density than the plastisol material.

3. The plastisol fishing lure of claim 1, wherein the displacement material has a lower density than the plastisol material.

4. The plastisol fishing lure of claim 1, wherein the displacement material is a mixture of material having a higher density and a lower density than the plastisol material.

5. The plastisol fishing lure of claim 1, wherein the displacement material is a metallic substance.

6. The plastisol fishing lure of claim 5, wherein the metallic substance consist predominantly of particles made from tungsten or an alloy of tungsten.

7. The plastisol fishing lure of claim 5, wherein the metallic substance consist predominantly of metallic powder.

8. The plastisol fishing lure of claim 1, wherein the displacement material comprises a metal insert that is substantially enveloped or substantially contained within a plastisol material that forms the body of the plastisol fishing lure.

9. The plastisol fishing lure of claim 1, wherein the displacement material is uniformly distributed substantially the entire lure.

10. The plastisol fishing lure of claim 1, wherein the displacement material is embedded in only particular areas of the lure.

11. The plastisol fishing lure of claim 1, wherein the displacement material is embedded in only one area of the lure.

12. A plastisol fishing lure comprising:
a body primarily constructed of a plastisol material;
a displacement material embedded within at least a portion of the plastisol material, the embedded displacement material having a density that is greater than density of the plastisol material.

13. The plastisol fishing lure of claim 12, wherein the displacement material is uniformly distributed over a significant portion of the lure and includes a metallic substance.

14. The plastisol fishing lure of claim 13, wherein the metallic substance is a metallic powder.

15. The plastisol fishing lure of claim 13, wherein the metallic substance is metallic particles.

16. The plastisol fishing lure of claim 12, wherein the displacement material is a metallic substance and is non-uniformly dispersed within at least a portion of the lure.

17. The plastisol fishing lure of claim 12, wherein the displacement material is a metallic substance and is concentrated at one or more locations in the lure.

18. The plastisol fishing lure of claim 12, wherein the displacement material is a metallic substance and is distributed in such a manner that the density of the metallic substance at one portion of the lure is different from the density at another portion of the lure.

19. A plastisol fishing lure comprising:
a body primarily constructed of a plastisol material;
a displacement material embedded within at least a portion of the plastisol material, the embedded displacement material having a density that is substantially different than density of the plastisol material and is concentrated in one or more regions within the body.

20. The plastisol fishing lure of claim 19, wherein the displacement material is a metallic substance.

21. The plastisol fishing lure of claim 19, wherein the displacement material has a less density than the plastisol fishing lure.
